(19) United States
(12) Patent Application Publication
(10) Pub. No.: US 2024/0353221 A1
(43) Pub. Date: Oct. 24, 2024

(54) Shape Sensing System And Method For Anthropomorphic Test Devices

(71) Applicant: Humanetics Innovative Solutions, Inc., Farmington Hills, MI (US)

(72) Inventors: Rogerio Tadeu Ramos, Eastleigh (GB); Christopher Emslie, Romsey (GB)

(73) Assignee: Humanetics Innovative Solutions, Inc., Farmington Hills, MI (US)

(21) Appl. No.: 18/762,326

(22) Filed: Jul. 2, 2024

Related U.S. Application Data
(62) Division of application No. 17/432,241, filed on Aug. 19, 2021, now Pat. No. 12,050,098.
(60) Provisional application No. 62/808,028, filed on Feb. 20, 2019.

(51) Int. Cl. G01B 11/24; G01D 5/353; G02B 6/02; G09B 23/32

(52) U.S. Cl. CPC G01B 11/24; G01D 5/35316; G02B 6/02042; G02B 6/02128; G09B 23/32

(57) ABSTRACT

A shape sensing system for an anthropomorphic test device is disclosed that includes a plurality of body parts and at least one optical fiber that has a plurality of cores in a spaced and parallel relationship with one another that extend between ends of the optical fiber for sensing positions of the body parts. Each of the cores have a plurality of grating sensors disposed along a length thereof capable of determining a position and orientation of the body parts.

### RELATED APPLICATIONS

This application is a Division of U.S. patent application Ser. No. 17/432,241, filed on Aug. 19, 2021, which is the National Stage of International Application No. PCT/US2020/019078, filed on Feb. 20, 2020, which claims priority to and the benefit of U.S. Provisional Patent Application No. 62/808,028, filed on Feb. 20, 2019, all of which are hereby incorporated by reference.

### BACKGROUND

### 1. Field of the Invention

The present invention relates generally to anthropomorphic test devices and, more particularly, to a shape sensing system for an anthropomorphic test device.

### 2. Description of the Related Art

Automotive, aviation, and other vehicle manufacturers conduct a wide variety of collision testing to measure the effects of a collision on a vehicle and its occupants. Through collision testing, a vehicle manufacturer gains valuable information that can be used to improve the vehicle.

Collision testing often involves the use of anthropomorphic test devices (ATD), commonly referred to as “crash test dummies.” During collision testing, the ATD is placed inside a vehicle and the vehicle undergoes a simulated collision (sled test) or physical collision. The collision exposes the ATD to high inertial loading, and sensors inside the ATD, such as accelerometers, strain gauges, and other sensors, generate electrical signals of data corresponding to the loading. Cables transmit these electrical signals of data to a data acquisition system (DAS) for subsequent processing. This data reveals information about the effects of the collision on the anthropomorphic test device and can be correlated to the effects a similar collision would have on a human occupant.

The movement and distortions of the ATD during a crash test have also been monitored visually using high speed cameras in the past. However, some tests cannot be monitored in this way because of the construction of the structure surrounding the ATD, the presence of other dummies, or the inflation of air bags. Also, the position or shape of individual parts of the ATD may be difficult to estimate, such as limbs and internal organs. Simulated soft organs are particularly difficult to monitor using traditional strain gauges where it is difficult to measure strain of low Young modulus materials using high Young modulus sensing elements.

The ATD is highly adjustable to allow for many different configurations. Thus, it is difficult to reposition the ATD into precisely the same position and orientation for subsequent tests. Cameras can be used to realign the ATD, but there is less certainty that the position and orientation is the same. If the position and orientation of the ATD differs between subsequent tests, the results may differ.

### SUMMARY

Accordingly, the present invention provides a system for sensing a shape of an anthropomorphic test device. The system comprises a plurality of body parts forming the anthropomorphic test device and the ATD simulates at least a part of a human body. At least one optical fiber is supported by at least one of the body parts with the optical fiber extending between a first end and a second end. The at least one optical fiber has a plurality of cores extending between the first and the second ends and the cores are in a spaced and parallel relationship with one another between the first and the second ends. Each of the cores has a plurality of grating sensors inscribed integrally therein with the sensors spaced along a length between the first and the second ends. The grating sensors reflect an initial instance of light having a predetermined band of wavelengths as a first reflection. The first reflection corresponds to an initial position and orientation of the body parts prior to undergoing movement of the plurality of body parts. After the body parts are moved from the initial position and orientation, the grating sensors reflect a second instance of light as a second reflection. The second reflection corresponds to a reposition and reorientation of the body parts to compare to the first reflection of the initial position and orientation.

The present invention further provides a method for repeatably positioning an anthropomorphic test device by disposing at least one optical fiber throughout a plurality of body parts forming the anthropomorphic test device. The optical fiber has a plurality of cores extending between a first end and a second end with each of the cores being in a spaced and parallel relationship with one another. Each of the cores has a plurality of grating sensors inscribed integrally therein with the sensors spaced along a length between the first and the second ends. The anthropomorphic test device is positioned in an initial position and orientation of the body parts and an initial instance of a light is emitted through the cores of the optical fibers. An initial reflected light of the initial instance of the light from the sensors is detected that corresponds to the initial position and orientation. Next, the anthropomorphic test device is subjected to a sudden impact causing the body parts to move from the initial position and orientation. Then, the anthropomorphic test device is repositioned with the at least one optical fiber disposed thereabout and a second instance of a light is emitted through the cores of the optical fibers. A second reflected light of the second instance of the light from the sensors is detected and the anthropomorphic test device is continued to be repositioned and reoriented until the second reflection correlates with the initial reflection such that the position and orientation of the anthropomorphic test device corresponds to the initial position and orientation.

One advantage of the present invention is that a new shape sensing system is provided for an anthropomorphic test device. The shape sensing systems utilizes an optical fiber that is positioned throughout the ATD. The optical fiber is also small and lightweight minimizing interference with the test. The optical fibers are typically formed of a silica based fiber which is very stable and provides repeatable test results. The use of optical fiber as sensing elements has also the advantage of having the electronics remote from the location of sensing. Another advantage is that the optical fiber is insensitive to electromagnetic noise in the environment.

The subject invention allows the ATDs to be used in tests other than a crash or collision test, including the drops, parachuting, spacecraft launches, etc., that require precise positioning of the ATD before the test and subsequent tests to ensure repeatability of the test and accuracy of the test results. The precise positioning is aided by the plurality of cores, which provides additional positional data for the various body parts. The plurality of cores also increases the sensitivity of the optical fiber and the system as a whole.

Other features and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a perspective view of one embodiment of a shape sensing system, according to the present invention, having a plurality of body parts forming an anthropomorphic test device with at least one optical fiber supported thereon.

FIG. 2 is a side view of the shape sensing system illustrated in FIG. 1.

FIG. 3 is a partial cut away, perspective view of an optical fiber for use in the shape sensing system of the subject invention.

FIG. 4 is a schematic view of the optical fiber in communication with a control box according to one embodiment of the subject invention

FIG. 5 is a schematic view of the optical fiber according to one embodiment of the subject invention.

FIG. 6 is an end view of another embodiment of an optical fiber for use with the subject invention.

FIG. 7 is an end view of still another embodiment of an optical fiber for use with the subject invention.

FIG. 8 is a perspective view of the fiber bundle shown in FIG. 7.

FIG. 9 is an end view of one embodiment of a fiber bundle of collocated optical fibers for use in the subject invention.

FIG. 10 is a perspective view of the fiber bundle shown in FIG. 9.

### DETAILED DESCRIPTION

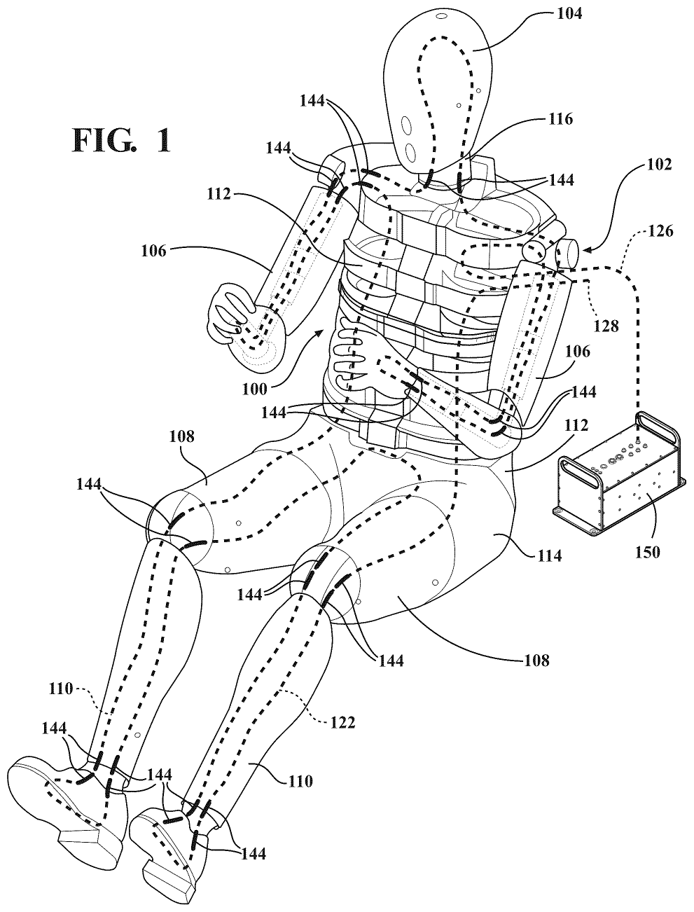

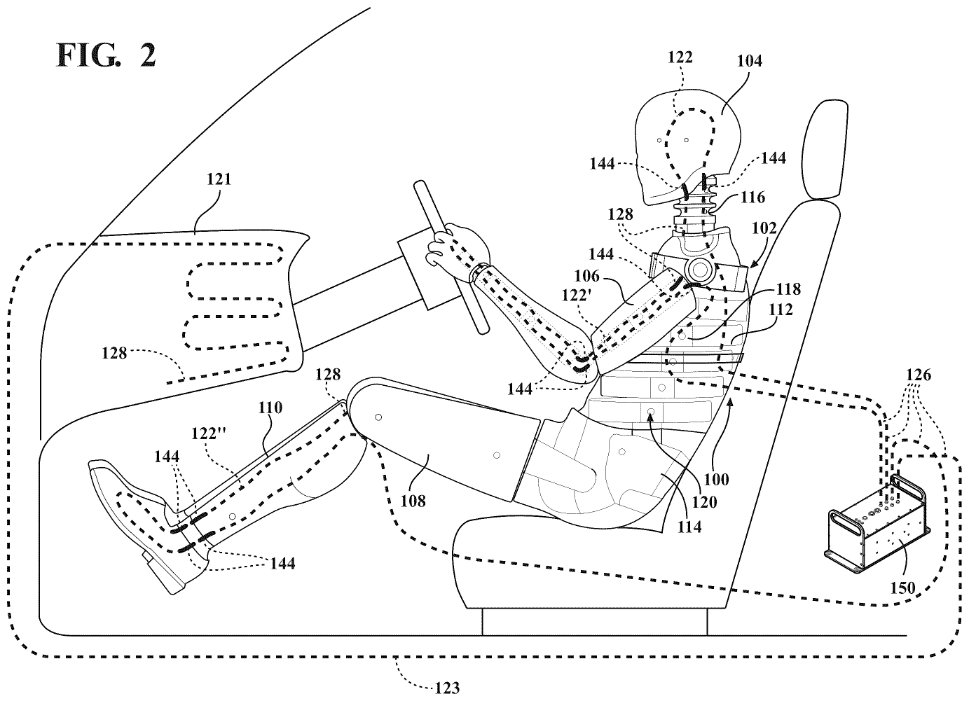

Referring to the drawings and in particular FIGS. 1 and 2, one embodiment of a shape sensing system 100, according to the present invention, is shown in operational relationship with an anthropomorphic test device (ATD), generally indicated at 102. The anthropomorphic test device 102, in the example shown, is of a fiftieth percentile (50%) male type and is illustrated in a sitting position. It should be appreciated that the shape sensing system 100 would apply to all types of ATD 102. The sensing system 100 can be used to sense shape or position of the ATD 102 or part of an ATD 102 such that the position can be maintained or precisely realigned for subsequent tests.

In one embodiment, the system 100 is used primarily, but without limitation, to test the performance of interiors and systems for seat occupants that undergo an impact or a crash. In another embodiment, the system 100 can be used to test a plurality of components forming a part of at least one of a vehicle and a testing stand. This can also include specifically testing the performance of automotive interiors and restraint systems for adult front and rear seat occupants. Referring to automotive interior components, this may include seats, restraints, consoles, steering columns, steering wheels or any interior component subject to impact. Other vehicles that can be tested include, but are not limited to, airplanes and the associated interior components, which may include seats, restraints, hull, head liners, seat trays and the like.

The size and weight of the ATD 102 is based on anthropometric studies, which are typically done separately by the following organizations, University of Michigan Transportation Research Institute (UMTRI), U.S. Military Anthropometry Survey (ANSUR), and Civilian American and European Surface Anthropometry Resource (CESAR). It should be appreciated that ranges of motions, centers of gravity, and segment masses simulate those of human subjects defined by the anthropometric data. The ATD 102 can also be used to test the force of impacts on a simulated human body directly in various testing stands, such as neck twist fixtures, chest impact fixtures, and the like. The ATD 102 can also be used to test the force of impacts on a simulated human body directly in various testing stands or test fixtures, such as neck twist fixtures, chest impact fixtures, and the like. Test fixtures can also include various parts of the vehicle. Similarly, the optical fiber 122 can be supported by and in contact with such testing stands to test impacts thereon.

The system 100 includes a plurality of body parts forming the anthropomorphic test device and simulates at least a part of a human body and articulation thereof. The body parts typically include a rigid body part and a flexible body part. Rigid body parts of the ATD 102 are meant to mimic and/or simulate rigid body parts of a human body, such as bone. Flexible body parts are meant to mimic and/or simulate flexible body parts of the human body, such as flesh, muscle, tissue, organs, and the like. The ATD 102 combines rigid and flexible body parts to more accurately represent the human body. For example, an arm assembly includes the rigid body part corresponding to the bones and the flexible body part corresponding to the flesh, muscle, and tissue. Referring to the flexible body parts, it should be appreciated that various materials, such as a urethane or plastic can be used to form the flexible body parts for improved coupling with the rigid body parts of the anthropomorphic test device.

As shown generally in FIG. 1, the ATD 102 includes a head assembly 104, a right and left arm assembly 106, a right and left upper leg assembly 108, a right and left lower leg assembly 110, a thorax assembly 112, and a pelvis assembly 114. An instrumentation core may be mounted within the various body parts and may be removable for access to the body part. It should be appreciated that the right and left assemblies are generally constructed in a similar manner. It is to be appreciated by one of ordinary skill in the art that the individual components forming the ATD 102 are well known and can be varied based on the particular ATD 102 without deviating from the subject invention.

FIG. 2 shows a neck assembly 116 that connects the head assembly 104 to the thorax assembly 112. The thorax assembly 112 also includes a spine assembly 118 having an upper end mounted to the head assembly 104 and a lower end extending into a torso area of the ATD 102. The thorax assembly 112 also includes a rib cage assembly 120 connected to the spine assembly 118.

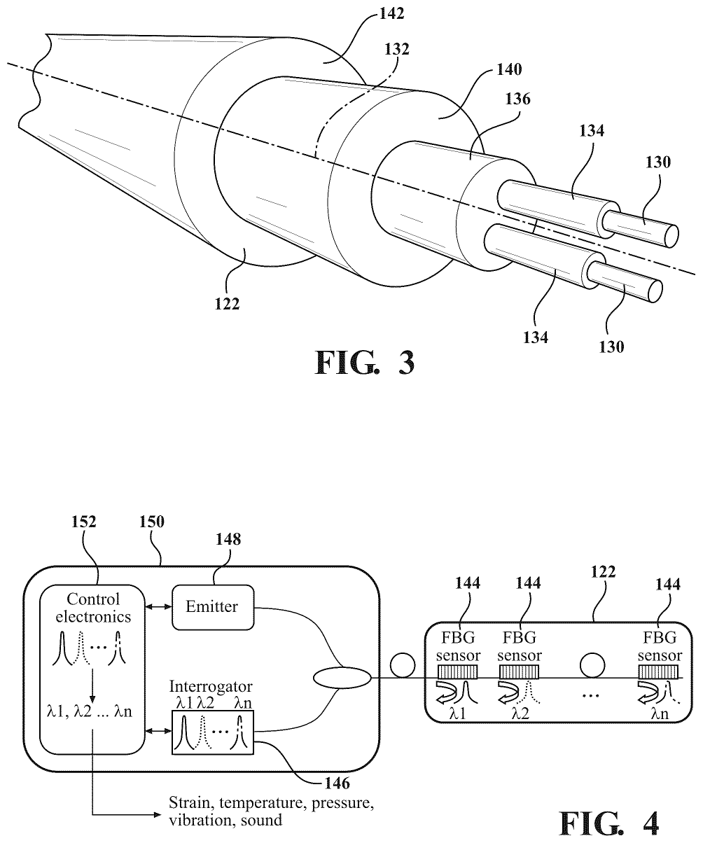

Referring again to FIGS. 1 and 2, the shape sensing system 100, according to the present invention, includes at least one optical fiber 122 extending between first and second end 126, 128 and throughout the ATD 102. Yet another optical fiber 123 is disposed in the interior component, such as a dashboard 121. Referring to FIG. 3, the optical fiber 122 has a plurality of cores 130, i.e. multiple cores 130 that extend between the first and the second end 126, 128 and are in a spaced and parallel relationship with one another. The optical fiber 122 further defines a longitudinally extending, fiber axis 132. The plurality of cores 130 may include one core located along the fiber axis, such as a central core, and other cores spaced from the central core, such as satellite cores. Alternatively, the plurality of cores 130 could include only the satellite cores. The optical fiber 122 may mount directly to a surface of the body part or is embedded within the body part. It is to be appreciated that mounting can be achieved with adhesive, glue, tape, or the like. It is to be appreciated that embedding the optical fiber can be achieved by various methods as such as by molding or casting the body part around the optical fiber. It is also possible that the body part could be 3D printed about the optical fiber or vice versa.

In this embodiment, each core 130 is surrounded by a cladding material 134 and two cores 130 extend parallel to one another and are spaced from the fiber axis 132. A coating material 136 surrounds the cladding material 134 to provide strength to the core 130 and cladding material 134. Optimally, although not necessarily, a strength member 140 and an outer jacket 142 may also surround the coating material 136 to provide additional strength to the optical fiber 122. However, it is to be appreciated that the various layers may depend on the configuration of the plurality of cores 130.

A schematic view of the system 100 is shown in FIG. 4 in communication with one of the cores 130. Each of cores 130 has a plurality of grating sensors 144 disposed along a length thereof such that the system 100 is capable of determining a position and orientation of the body parts. The grating sensors 144 are inscribed integrally therein with the sensors 144 spaced along a length between the first and the second ends 126, 128. The number of grating sensors 144 can be selected based on the particular body part. For example, the optical fiber 122 can have from 7 to 25 sensors 144 disposed between the ends. Other embodiments can have up to 100 sensors 144 per core 130. The sensors 144 may be located near or adjacent joints, such as elbow, hip, shoulder, knee, or ankle joint as shown schematically in FIGS. 1 and 2. The sensors 144 may be located at the joint to accurately measure rotation and orientation of the joint. For certain body parts, the sensors 144 may be disposed equidistance from one another along the optical fiber 122 and about the body part. For other body parts, the sensors 144 may be more closely located to one another.

The system 100 includes an interrogator 146 communicating with the optical fiber 122 and an emitter 148 in communication with the optical fiber 122 for emitting a light having a predetermined band of wavelengths through the optical fiber 122 that is reflected by the sensors 144. The subject invention may enclose the interrogator 146 and the emitter 148 within a control box (shown generally at 150 in FIGS. 1 and 2). The control box 150 may also house a controller 152. A suitable control box 150, emitter 148, and interrogator 146 are disclosed in co-pending Application PCT/US19/14878, filed Jan. 24, 2019, which is incorporated herein by reference. As one example, the emitter 148 emits the light having a predetermined band wavelength that is from 50 to 450 nanometers. In one embodiment, the wavelength band can be in the range of 1510-1595 nanometers. In another embodiment, the wavelength band can be in the range of 1275-1345 nanometers. In still another embodiment, the wavelength band can be in the range of 780-850 nanometers. It is also possible that the wavelength band is suitable for red diode lasers. It is to be appreciated that these wavelength bands are exemplary and are not intended to limit the subject invention.

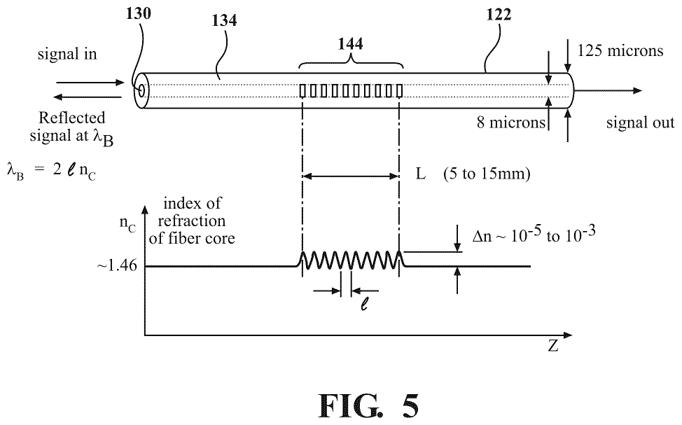

Referring to FIG. 5, another schematic view of one of the optical fibers 122 and sensors 144 are shown having light directed down the core 130 that is reflected by the Fiber Bragg Grating as is understood by those of ordinary skill in the art. The sensor 144 has a length L and the light has a wavelength 1. It is to be appreciated by one of ordinary skill that the grating sensors 144 are generally a longitudinal variation in the refractive index of the core 130. The core 130 has an index of refraction, nc that is selected for the particular application. It is well known to one of ordinary skill in the optical fiber 122 arts to correlate the reflected light from the sensor 144 using the wavelength 1, length L, and index of refraction nc.

The optical fiber 122 may have a diameter of from 30 to 1000 microns. In one embodiment, the optical fiber 122 has a diameter of from 100 to 300 microns. Each of the cores 130 may have a same diameter or different diameters. In one embodiment of the system 100, each of the cores 130 has a diameter of from 2 to 900 microns. In another embodiment, each of the cores has a diameter of from 2-300 microns. Alternatively, the core 130 would typically have a diameter of less than 30 microns, and particularly from 5-20 microns. One preferred optical fiber 122 has a core 130 with a diameter of about 8 microns. The cladding material 134 is typically about 75-200 microns and particularly from 100-150 microns. In another embodiment, the optical fiber 122 has a diameter of from 100 to 200 microns. The optical fiber 122 can be sized for the particular body part. One common diameter for the optical fiber 122 is about 75-150 microns.

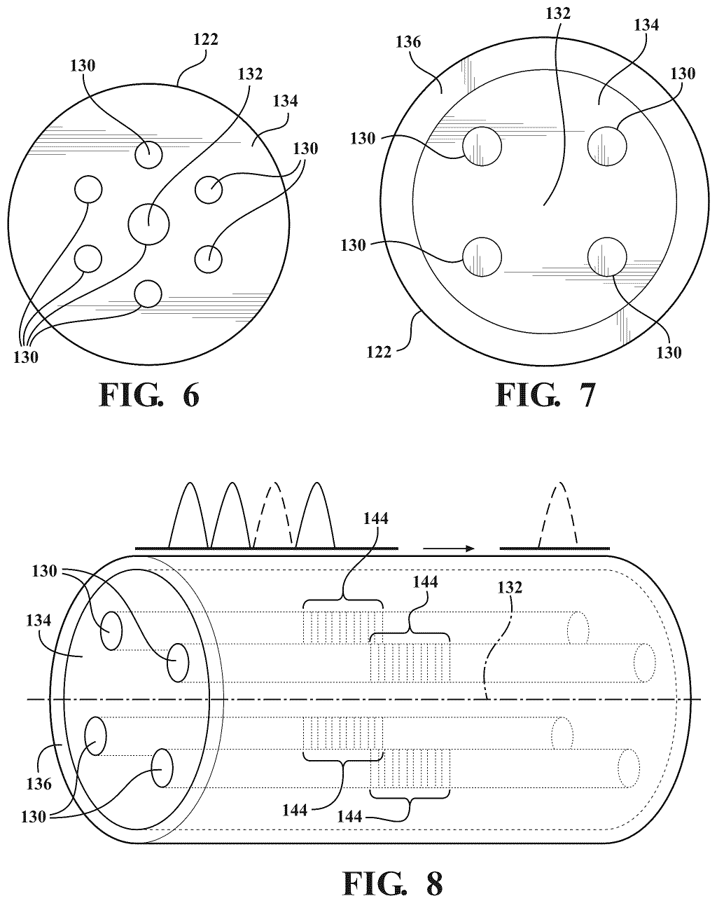

Referring to FIG. 6, another embodiment of the optical fiber 122 is shown having seven cores 130 and the cladding material 134. In this embodiment, one of the cores 130 extends along the fiber axis 132 of the optical fiber 122 and the remaining six cores 130 are spaced equally about the fiber axis 132. Further, the optical fiber 122 may include the coating material 136, which is not shown. FIG. 7 shows another embodiment of the optical fiber 122 that has four cores 130 spaced from one another and the cores 130 extend parallel to each other along the optical fiber 122. The cores 130 are shown having a single cladding material 134 and coating material 136 surrounding the four cores 130. FIG. 8 is a perspective view of the optical fiber 122 shown in FIG. 7 and illustrates the light transmitted through one of the cores 130 as waves. In this example, three of the waves are reflected by the sensor 144 and one wave would continue. The optical fiber 122 has a plurality of grating sensors 144 positioned along each of the cores 130 of the optical fiber 122 which may reflect the other waves. The sensors 144 can be located adjacent to or offset from one another. The spacing of the grating sensors 144 determine the particular wavelength that will be reflected by the grating sensor 144. It is well known that each grating sensor 144 has its own period and thereby its own unique reflection wavelength, so that each sensor can be distinguished by the detected reflection.

As the optical fiber 122 bends and conforms to the shape of the body parts, the sensors 144 change from stress or strain and can provide bend and shape measurement when multiple cores 130 are interrogated as described above. The same fibers would enable tracking of the precise shape, position and movements of the ATD 102 in real time. The detection of strain could be provided by Fiber Bragg Gratings (FBGs), Brillouin scattering, Rayleigh scattering, interferometers, or any other optical technique. Although the grating sensors 144 are described as integral with the optical fiber 122, it is to be understood by one of ordinary skill in the art that optical time domain reflectometry (OTDR) could be used with Brillouin or Rayleigh scattering to achieve the subject invention by using a time of pulse to determine the location of the strain. One advantage of having the cores 130 placed side by side is that it can be used for bend measurement. Referring back to FIG. 6, the centrally located core 130 can be used for measurement or compensation of total strain or temperature because it is along the fiber axis 132 of the fiber 122.

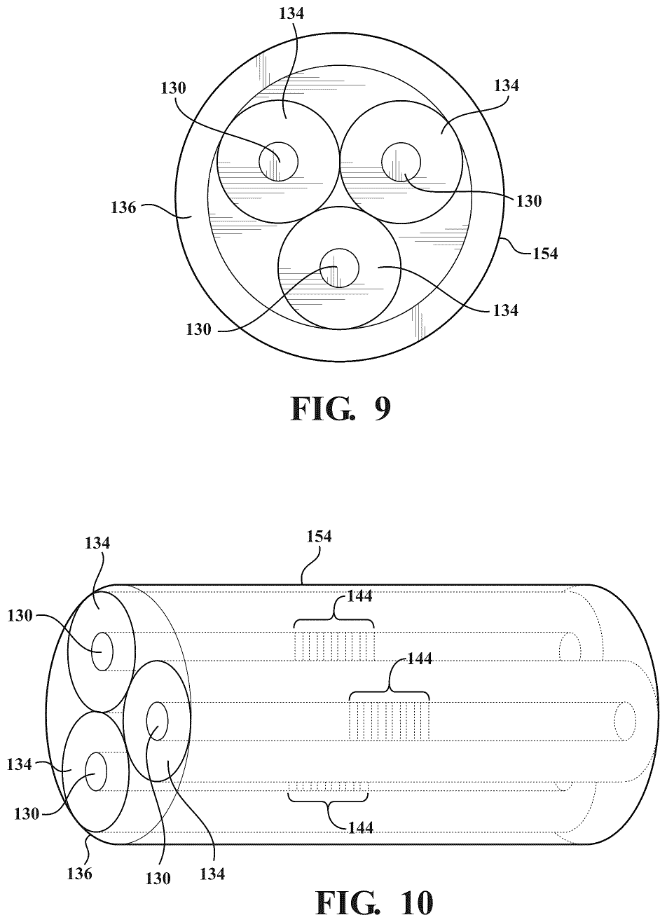

With reference to FIG. 9, another embodiment of at least one of the optical fibers 122 is a fiber bundle 154 of collocated optical fibers 122. The fiber bundle 154 includes three collocated optical fibers 122, each having the core 130 and the cladding 134. FIG. 10 is a perspective view of the optical fiber 122 shown in FIG. 9. The bundle can contain multiple collocated fibers or different sections of the same fiber. The collocated fiber can have a single core 130 or multiple cores 130. The collocated optical fibers 122 may be connected to each other by the cladding 134 or any other layers that are included with the optical fiber 122. A suitable adhesive may be used to attach the collocated optical fibers 122 together. Alternatively, the collocated optical fibers 122 may slide freely next to each other.

The subject invention allows shape information to be extracted from differential strain measurements from the different cores 130. In one embodiment, the optical fiber 122 has a length that extends through the body parts of the ATD 102. Preferably, the length is sufficient that one single optical fiber 122 can extend through the head, neck, arm, thorax, pelvis and upper and lower leg assemblies. Alternatively, each of the body parts can receive its own optical fiber 122. For example, the shape sensing can be used to detect the position of each limb, head, body or organs in relation to the spine or in relation to the surrounding environment which could be a car or a seat.

The sensing system 100 can be attached to parts of the ATDs 102 such as neck, spine, joints, internal organs, bones, ribs or any part and the sensing system 100 can be used for a method for repeatably positioning the anthropomorphic test device 102. Referring back to FIG. 1, the optical fiber 122 is disposed throughout a plurality of body parts forming the anthropomorphic test device to monitor the shape of the ATD 102 by sensing different parts such as torso, limbs and head. The ATD 102 is positioned in an initial position and orientation of the body parts and an initial instance of a light is emitted through the cores 130 of the optical fibers 122. An initial reflected light of the initial instance of the light, or first reflection, from the sensors 144 that corresponds to the initial position and orientation is detected with the interrogator 146, which communicates with the controller 152. Next, the ATD 102 is moved, such as by being subjected to a sudden impact causing the body parts to move from the initial position and orientation. This can be as a result of performing a collision test or an impact test. The ATD 102 could also be moved from one testing fixture to another. Alternatively, the ATD 102 could have been inadvertently moved during setup. The ATD 102 is repositioned with the optical fiber 122 disposed thereabout. The optical fiber 122 may have remained on the ATD 102 during the test or it could be repositioned after the test. For example, the ATD 102 could be initially positioned with an optical fiber vest that is removed for a test and then reinstalled for the next test.

A second instance of a light is emitted through the cores of the optical fibers and a second reflected light, or a second reflection, of the second instance of the light from the sensors is detected. The ATD 102 is continued to be repositioned and reoriented until the second reflection correlates with the initial reflection such that the position and orientation corresponds to the initial position and orientation. The controller 152 outputs the display of the reflections of the first and second instance of light such that the ATD 102 can be adjusted until the second reflection adequately compares to the first reflection as would be acceptable to those of ordinary skill in the art. The output could be viewed manually or by the controller 152. The correlation between the first and the second reflection does not have to be exact, but the closer the correlation, the better the likelihood for repeatable test results from the subsequent test. In many existing systems, the positioning of the ATD 102 is performed manually so there is variation between positions and orientations that produce different results from the same test. Therefore, the subject invention seeks to overcomes this deficiency by knowing the precise position and ordination at the beginning which can be repeated for each subsequent test.

Thus, the subject invention allows for the precise positioning of the ATD 102 prior to subjecting the ATD 102 to a test or any movements. Once a starting position and orientation of the ATD 102 is known or registered, the ATD 102 can be repositioned in the same position and orientation for subsequent test. The subject invention also allows for the detection of bending of joints, such as elbows, knees, or neck, before, during and after a test. Each joint may include the sensor 144 positioned adjacent thereto such that each sensor 144 provides its unique reflection that includes frequency, period, or peak. If the subsequent reflection for each does not have the same frequency, period, or peak, the joint can be further positioned until properly aligned. The ability to repeatedly place the ATD 102 in the correct or same position before the test and for subsequent tests considerably improves the test results. Further, being able to reposition and reorient the ATD 102 in the same initial position ensures accuracy of various tests which can be repeated multiple times.

The present invention has been described in an illustrative manner. It is to be understood that the terminology, which has been used, is intended to be in the nature of words of description rather than of limitation.

Many modifications and variations of the present invention are possible in light of the above teachings. Therefore, the present invention may be practiced other than as specifically described.

What is claimed is:

1. A method for repeatably positioning an anthropomorphic test device within a testing stand, said method comprising the steps of:
disposing a plurality of optical fibers throughout the anthropomorphic test device wherein a first optical fiber is disposed through at least a head and neck assembly of the anthropomorphic test device, a second optical fiber is disposed through at least an arm assembly of the anthropomorphic test device, and a third optical fiber is disposed through at least a leg assembly of the anthropomorphic test device;
each of the optical fibers having a plurality of cores extending between a first end and a second end and each of the cores having a plurality of grating sensors inscribed integrally therein with the sensors spaced along a length between the first and the second ends;
positioning the anthropomorphic test device within the testing stand and arranging the head and neck assembly, the arm assembly, and the leg assembly into an initial position and orientation;
emitting an initial instance of a light through the cores of each of the optical fibers;
detecting an initial reflected light of the initial instance of the light from the sensors that corresponds to the initial position and orientation;
subjecting the anthropomorphic test device to forces causing the head and neck assembly, the arm assembly, and the leg assembly to move from the initial position and orientation;
repositioning the anthropomorphic test device within the testing stand;
emitting a second instance of a light through the cores of each of the optical fibers;
detecting a second reflected light of the second instance of the light from the sensors; and
continuing to reposition and reorient the head and neck assembly, the arm assembly, and the leg assembly until the second reflection correlates with the initial reflection such that the position and orientation of the anthropomorphic test device corresponds to the initial position and orientation.

2. A method as set forth in claim 1 wherein disposing said plurality of optical fibers further comprises the step of disposing an additional optical fiber in an interior component of the testing stand.

3. A method as set forth in claim 1 wherein at least one grating sensor of the first, second, or third optical fiber is disposed adjacent to at least one joint of the head and neck assembly, the arm assembly, and the leg assembly.

4. A method as set forth in claim 1 wherein the optical fiber has a longitudinally extending fiber axis with one of the cores located along the axis.

5. A method as set forth in claim 1 wherein each of the cores has a diameter of from 5 to 20 microns.

6. A method as set forth in claim 1 wherein the plurality of cores includes at least three cores.

7. A method as set forth in claim 1 wherein the plurality of optical fibers are surface mounted.

8. A method as set forth in claim 1 wherein the step of disposing the plurality of optical fibers is further defined as disposing the plurality of optical fibers in an optical fiber vest that is removable from the anthropomorphic test device.

9. A method for repeatably positioning an anthropomorphic test device within a testing stand, said method comprising the steps of:
disposing at least one ATD optical fiber throughout a plurality of body parts forming the anthropomorphic test device and disposing at least one additional optical fiber in an interior component of the testing stand, each of the at least one ATD optical fiber and the additional optical fiber having a plurality of cores extending between a first end and a second end and each of the cores having a plurality of grating sensors inscribed integrally therein with the sensors spaced along a length between the first and the second ends;
positioning the anthropomorphic test device within the testing stand in an initial position and orientation of the body parts;
emitting an initial instance of a light through the cores of the at least one ATD optical fiber and the additional optical fiber;
detecting an initial reflected light of the initial instance of the light from the sensors that corresponds to the initial position and orientation of the plurality of body parts and the interior component;
subjecting the anthropomorphic test device to forces causing the body parts to move from the initial position and orientation;
repositioning the anthropomorphic test device within the testing stand;
emitting a second instance of a light through at least the cores of the at least one ATD optical fiber and the additional optical fiber;
detecting a second reflected light of the second instance of the light from the sensors that corresponds to the current position and orientation of the plurality of body parts and the interior component; and
continuing to reposition and reorient the anthropomorphic test device until the second reflection correlates with the initial reflection such that the current position and orientation of the anthropomorphic test device corresponds to the initial position and orientation.

10. A method as set forth in claim 9 wherein the step of disposing the at least one ATD optical fiber throughout the plurality of body parts is further defined as disposing the at least one ATD optical fiber in an optical fiber vest that is removable from the anthropomorphic test device.

11. A method as set forth in claim 9 wherein at least one grating sensor of the at least one ATD optical fiber disposed throughout the body parts is disposed adjacent to at least one joint of the plurality of body parts.

12. A method as set forth in claim 9 wherein the step of disposing the at least one ATD optical fiber throughout the anthropomorphic test device is further defined as disposing a first optical fiber through at least a head and neck assembly, disposing a second optical fiber through at least an arm assembly, and disposing a third optical fiber through at least a leg assembly.
